(19) United States
(12) Patent Application Publication
(10) Pub. No.: US 2018/0070526 A1
(43) Pub. Date: Mar. 15, 2018

(54) APPARATUS AND METHOD TO MINIMIZE TRANSPORT DIMENSIONS OF AGRICULTURAL IMPLEMENTS

(71) Applicant: CNH Industrial Canada, Ltd., Saskatoon (CA)

(72) Inventor: James W. Henry, Saskatoon (CA)

(73) Assignee: CNH Industrial Canada, Ltd., Saskatoon (CA)

(21) Appl. No.: 15/263,650

(22) Filed: Sep. 13, 2016

(51) Int. Cl. A01B 73/04; A01B 63/32

(52) U.S. Cl. CPC A01B 73/046; A01B 63/32

(57) ABSTRACT

The transport dimensions of an agricultural implement having ground engaging components are minimized by the provision of sub fames to enable the ground engaging components to retract relative to their associated frame member so that the inboard and outboard frame members may be folded and kept in a transport position providing maximum clearance between opposed elements and a minimum overall width and height.

### BACKGROUND OF THE INVENTION

### 1. Field of the Invention

The present invention relates to agricultural implements, and, more specifically, to implements that are folded from an extended field position to a transport position.

### 2. Description of the Related Art

In the continuous quest to provide more efficient farming operations, folding agricultural implements have been constructed to provide ever increasing lateral width. As a result, a given pass through a field processes a greater number of rows. While this approach is fine for in field operation, the access between fields frequently requires a transport dimension in terms of width and height that is greatly reduced. In certain jurisdictions, governmental regulations provide limits on the transport dimensions, both width wise and height wise.

It is current practice to use folding implements having a center frame member and at least inboard and outboard frame members articulated between a field position in which the frame members are fully extended and a transport position in which they are folded onto the center section for transport. One of the problems with the current arrangement is that the ground engaging elements carried by the frame member frequently extend sufficiently to penetrate below the surface of the soil. As a result, when the frame member members are folded in the final position, the ground penetrating elements can have insufficient clearance. Furthermore, the wheels providing ground support for the frame members in the field position can end up interfering with one another or having an insufficient clearance.

Accordingly, what is needed in the art is an apparatus and method for minimizing the interference of components and the overall transport dimensions of a folding agricultural implement.

### SUMMARY OF THE INVENTION

The present invention seeks to minimize the folded transport dimensions of an agricultural implement.

In one form, the invention is a folding frame ground engaging implement including a center frame member and ground support wheels connected to the center frame member for guiding the center frame member in a travel direction. At least inboard and outboard frame members are articulated to the center frame member and to each other for extending laterally to an elongated field position and folded onto one another in a transport position. Ground support wheels are provided for the inboard and outboard frame members. Ground engaging components are mounted to at least the outboard frame member for engaging the ground in a position extending from the outboard lateral frame member for engaging the ground. A device is provided for retracting the ground engaging component towards the outboard frame member before the outboard lateral frame member is folded onto the inboard frame member and a device is provided for retracting the outboard ground support wheels before the inboard frame member is folded onto the center frame member, thereby providing clearance between ground engaging components and ground support wheels in the transport position.

In another form, the invention is a method of folding a folding ground engaging implement having a center frame member and at least inboard and outboard frame members articulated to the center frame member and ground engaging wheels supporting the center, inboard and outboard frame members and ground engaging components mounted to at least the outboard frame members. The method includes the steps of retracting the ground engaging tillage devices towards the outboard lateral frame member and then folding the outboard lateral frame member over onto the inboard lateral frame member. The ground support wheels for the outboard lateral frame member are retracted and then the inboard lateral frame member is folded onto the center frame member.

An advantage of the present invention is a rapid and flexible shrinking of the overall envelope of an agricultural implement from its field position to its travel position.

Another advantage is that it allows a larger agricultural implement to stay within a governmental clearance limits when traveling on roads between fields.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a fore and aft view of an agricultural implement embodying the present invention in a field position;

FIG. 2 is a fragmentary side view of a portion of the implement of FIG. 1 in a field position;

FIG. 3 is a side view of a portion of the agricultural implement of FIG. 2 shown in a transport position;

FIG. 4 is a fragmentary side view of the agricultural implement of FIG. 1 with an alternative mechanism positioning the implement in its field position;

FIG. 5 is a side view of the implement of FIG. 4 shown in its transport position;

FIG. 6 is a fore and aft view of the agricultural implement of FIG. 1 shown in a transition from a field to the transport position; and

FIG. 7 is a fore and aft view of the agricultural implement of FIG. 1 shown in its transport position.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

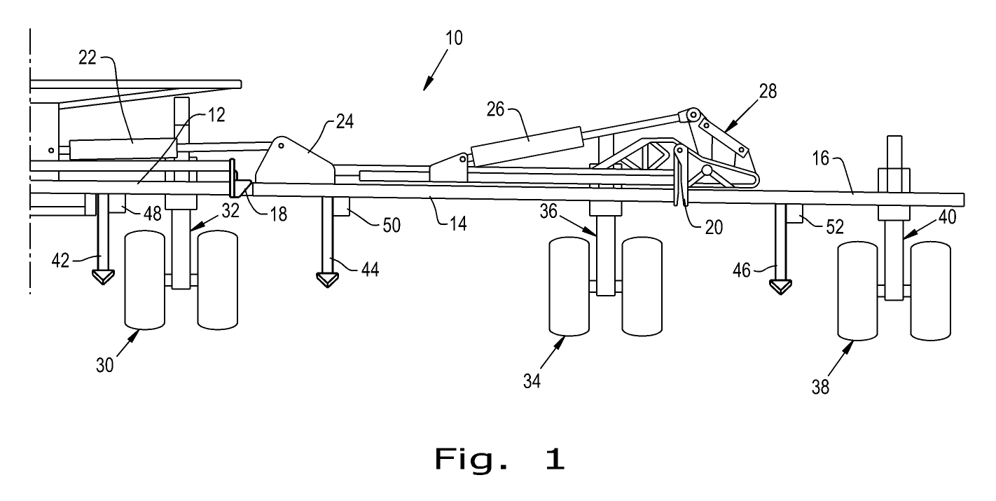

Referring now to the drawings, and more particularly to FIG. 1, there is shown an agricultural implement 10 in the form of a tillage implement for engaging and working the soil. It should be apparent to those skilled in the art that the present invention may be used for implements other than tillage implements and realize the same benefits. The implement 10 is shown in its field position and has a center frame member 12 extending on both sides of a symmetrical center line. Inboard frame members 14 and outboard frame members 16 are connected to their respective frame members by hinges 18 and 20. An actuator 22 and linkage 24 connected between frame members 12 and 14 allows the frame members to be pivoted from their illustrated flat position where they extend laterally relative to a direction of travel to a position where they are oriented at 90° respect to one another. Another actuator 26 and linkage 28 interconnect inboard frame member 14 and outboard frame member 16 to pivot the two from the illustrated flat plane position to a position wherein frame member 16 angles 180° with respect to frame member 14.

Ground support wheel assemblies 30 are connected to frame member 12 through a hydraulic lift mechanism 32 to set the level of the ground support wheel assemblies 30 relative to frame member 12 and thus set the field position subsequent transport positon in which the ground support wheel assemblies 30 are closer to the frame member. Another set of ground support wheel assemblies 34 are connected to frame member 14 via hydraulic lift mechanism to set the level of frame member 14 to keep it in a plane with a center frame member 12 during the illustrated field position and to retract the ground support wheel assemblies 34 during the transport position later discussed. Likewise, ground support wheel assemblies 38 are connected to the outboard frame member 16 via hydraulic lift mechanism to position the ground support wheel assemblies 38 from their extended field position in FIG. 1 to the transport position later discussed.

The agricultural implement has a plurality of ground engaging components 42, 44 and 46 connected to frame members 12, 14 and 16 respectively. It is contemplated that a plurality of ground engaging components 42, 44 and 46 are provided on each frame member, but only a small number are shown to simplify the understanding of the invention.

In accordance with the present invention, the ground engaging components 42, 44 and 46 have component support generally indicated at 48, 50 and 52 respectively to the frame members so that the ground engaging components may be retracted as well as the associated ground support wheel assemblies so that the agricultural implement 10 assumes a minimum overall dimension for transport purposes.

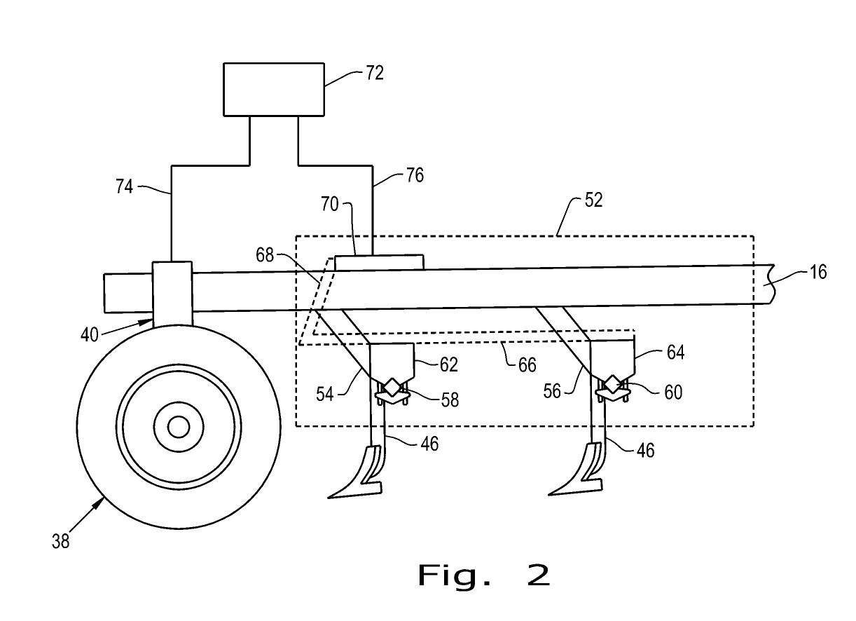

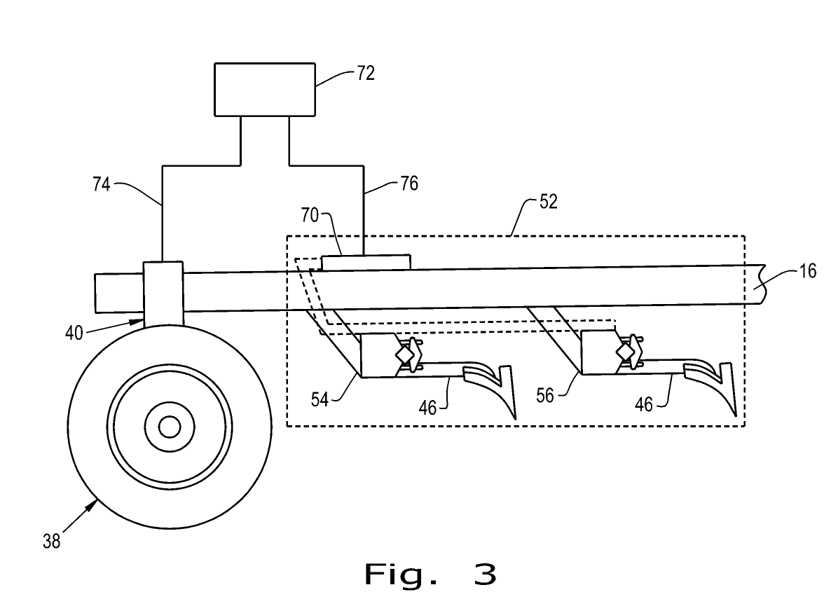

Referring now to FIG. 2, one form of component support 52 is illustrated for the agricultural implements 46 on the outboard frame member 16. It should be noted that similar component supports 48 and 50 would be provided for the ground engaging components on the inboard frame member and the center frame member 12. The component support 52 has a sub frame 54 and 56 respectively structurally connected to the frame member 16. The sub frames 54 and 56 each have a pivot 58 and 60, respectively about which bell cranks 62 and 64 pivot. The bell cranks 62 and 64 are respectively connected to the ground engaging components 46 so that the ground engaging components 46 are displaced between the field position shown in FIG. 2 and the transport position shown in FIG. 3. The field positioned has the ground engaging components 46 fully extended towards the field as shown in FIG. 2. The transport position is the position shown in FIG. 3 in which the ground engaging components are at a minimum distance from the associated frame member 16.

The arrangement in FIG. 2 allows the ground engaging components 46 to be pivoted simultaneously through the provision of an interconnecting link 66 which in turn connects to a link 68 extending to actuator 70. While other types of actuators may be used, as illustrated, actuator 70 receives control inputs from a hydraulic control unit 72 via a line 76. So also does the wheel assembly actuator 40 receive hydraulic inputs from line 74 to cause the wheel assembly actuator 40 to extend and retract the ground support wheel assemblies 38 relative to outboard frame member 16. Although the actuator and lines are shown in simplistic fashion to enable a clearer understanding of the present invention, it should be apparent to those skilled in the art that the actuators would have supply and return lines and the hydraulic control unit would include a source of hydraulic fluid under pressure and appropriate valves to direct the pressure to manipulate the actuators.

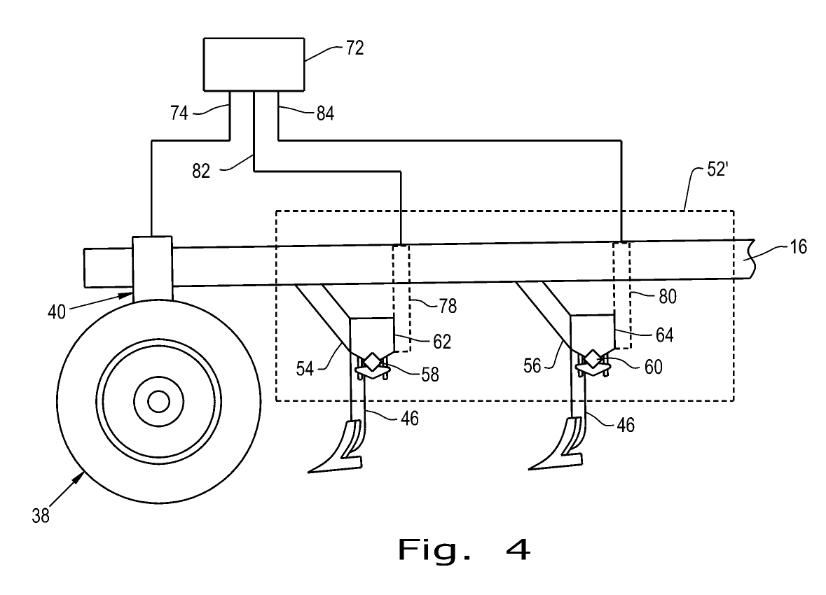

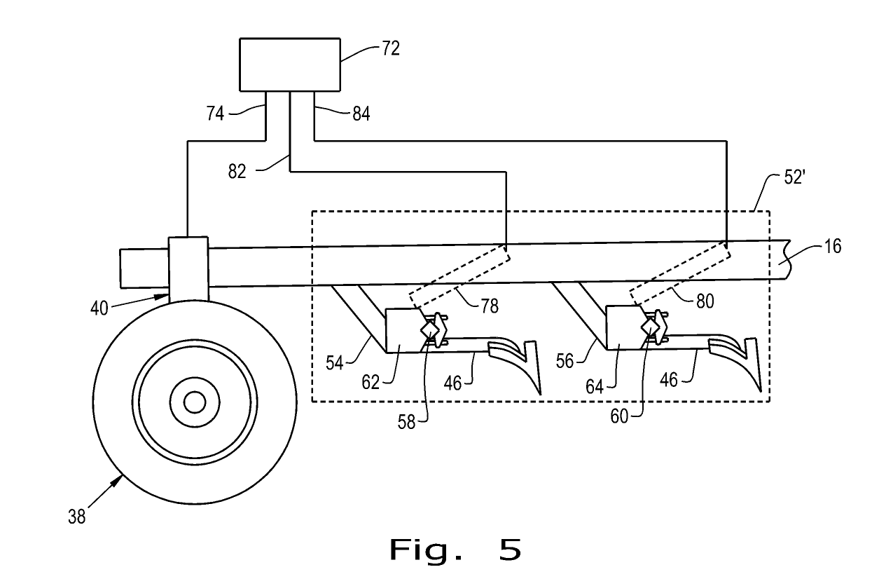

The operation of the arrangement shown in FIG. 2 utilizes a single actuator 70 to simultaneously operate adjacent ground engaging components 46 through the linkage 68 and 66. The arrangement of the component support 52′ in FIGS. 4 and 5 show an alternative arrangement. In these figures, equivalent components will be given the same reference numbers. In FIG. 4, there is shown an individual actuator 78 and 80 interconnected with bell cranks 64 of adjacent ground engaging components 46. The actuators 78 and 80 are connected to and controlled by hydraulic control unit 72 via lines 82 and 84. Thus, the actuators 78 and 80 are controlled to displace the ground engaging components 46 between their extended position shown in FIG. 4 and the retracted position shown in FIG. 5 by utilizing simultaneous pressure inputs to the actuators 78 and 80. The arrangement in FIGS. 4 and 5 is the equivalent of the arrangement in FIGS. 3 and 4 in that the ground engaging components 46 are simultaneously pivoted between the field positon and the transport position.

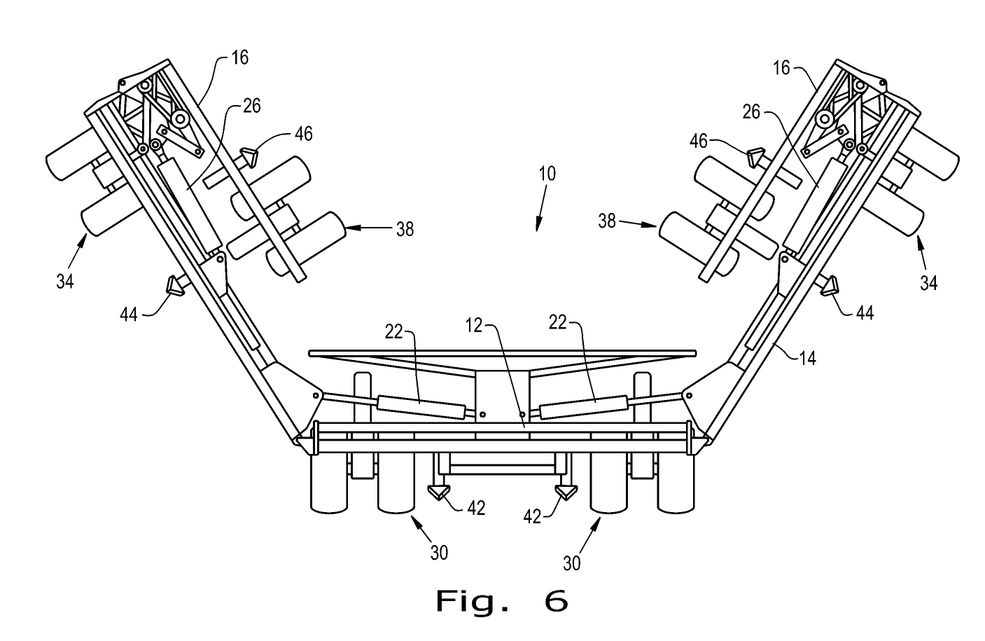

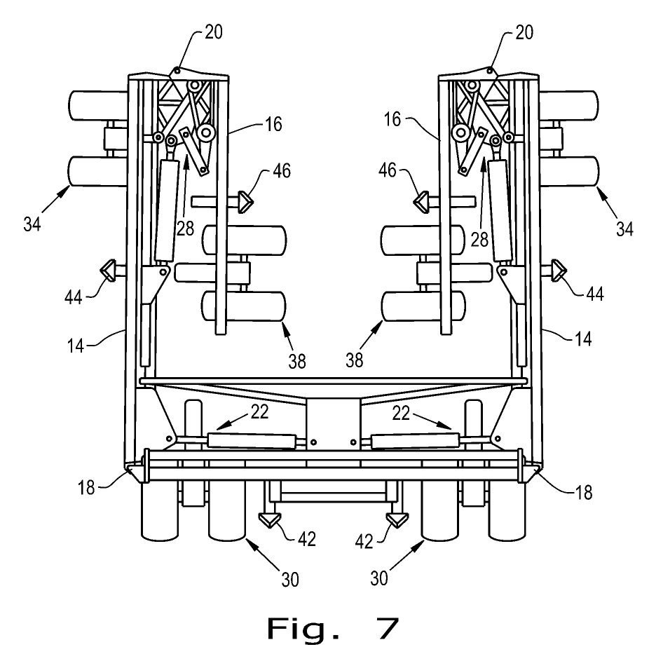

Turning now to the operation of either arrangement, reference is directed to FIGS. 6 and 7, in addition to FIG. 1. Starting with the position in FIG. 1 in which the ground engaging components and wheel assemblies are fully extended, the actuators are engaged to retract, move the implement from the field position to the transport position, the ground engaging components 42, 44 and 46 are fully retracted by the appropriate component support assemblies 48, 50 or 52 so that they have a minimum distance from their associated frame members as shown in FIG. 6. The ground support wheel assemblies 30, 34 and 38 are then retracted to their transport position in which they also have a minimum distance from the respective frame members. In a typical agricultural implement, the ground support wheel assemblies 30, 34, and 38 are extended or retracted in unison to set the depth of the ground engaging components 42, 44 and 46 in the field position. In this instance, the wheel assemblies 30, 34, and 38 are retracted to a minimum position using an existing control system, although it is possible to have individual wheel assembly control.

At this point, the outboard frame member 16 is pivoted by the actuator 26 and linkage 28 through a 180° arc as shown in FIG. 6. The inboard frame members 14 are then pivoted from a horizontal position in which they are coplanar with the center frame member 12 to their position in FIG. 7 in which the inboard frame members 14 form approximately a right angle with respect to the center frame member. Thus, it is seen that the clearance between adjacent ground engaging elements or components is greatly increased and the wheels are retracted so as to minimize the overall height from the ground to the junction of the inboard and outboard frame members 14 and 16.

At the same time, the width of the agricultural implement 10 is minimized because wheel assemblies 34 are fully retracted and at a minimum distance from the inboard frame member 14 so that the width is minimized.

The above arrangement enables agricultural implements of significant width to be deployed in a field while still providing an overall envelope that fits within road requirements of various government regulations. The provision of the component support shown in FIGS. 2 and 3 allows the introduction of the sub frame and retractable ground engaging components with a minimum of actuators. However, the arrangement shown in FIGS. 4 and 5 provides similar results.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A folding frame grounding engaging implement comprising:
a center frame member;
ground support wheels connected to said center frame member for guiding said center frame member in a travel direction;
at least inboard and outboard frame members articulated to said center frame member and to each other for extending laterally relative to the travel direction to an elongated field position and folded onto one another in a transport position;
ground support wheels for said inboard and outboard frame members;
ground engaging components mounted to at least the outboard frame member for engaging the ground in a position extending from said outboard frame member for engaging the ground; and,
a device for retracting said ground engaging components toward said outboard frame member before said outboard frame member is folded onto said inboard frame member and a device for retracting at least said outboard ground support wheels before said inboard frame member is folded onto said center frame member, thereby providing clearance between said ground engaging components and said ground engaging wheels in the transport position.

2. The folding frame ground engaging implement as claimed in claim 1, wherein at least the ground engaging components of said inboard frame member are retracted for folding into said transport position.

3. The folding frame ground engaging implement as claimed in claim 1, wherein the center frame member ground engaging components are retracted to said transport position.

4. The ground engaging implement as claimed in claim 1, wherein all the ground engaging components on said center frame member, inboard and outboard frame members are retracted to said transport position in unison.

5. The folding frame ground engaging implement as claimed in claim 1, wherein each of said ground engaging component is pivotally mounted on a sub frame.

6. The folding frame ground engaging implement as claimed in claim 5, further comprising linkage interconnecting at least two of the ground engaging components for simultaneous movement, and an actuator connected to said linkage for pivoting said ground engaging components between the extended field position and the retracted transport position.

7. The folding frame ground engaging implement as claimed in claim 6, wherein said actuator is hydraulic and said implement further comprises a hydraulic control system connected to said actuator for selective actuation.

8. The folding frame ground engaging implement as claimed in claim 5, further comprising an actuator connected to each said ground engaging component.

9. The folding frame ground engaging implement as claimed in claim 8, wherein said actuators are hydraulic and said implement further comprises a hydraulic control system for simultaneously activating said actuators to pivot said ground engaging components between the extended field position and the retracted transport position.

10. The folding frame ground engaging implement as claimed in claim 9, wherein the device for retracting said at least outboard ground support wheels comprises a hydraulic actuator connected to said hydraulic system for receiving signals to extend the ground support wheels to the field position and retract them to the transport position.

11. The folding frame ground engaging implement as claimed in claim 7, further comprising a hydraulic actuator connected to said at least said outboard ground support wheel, said hydraulic actuator being connected to said hydraulic control system for actuating said ground support wheel between said extended field position and said retracted transport position.

12. The folding frame ground engaging implement as claimed in claim 1, further comprising a hydraulic actuator connected to all of said ground support wheels, said hydraulic actuator being connected to a hydraulic control system for actuating said ground support wheels between said extended field position and said retracted transport position in unison.

13. A method of folding a folding ground engaging implement having a center frame member and at least inboard and outboard frame member members articulated to the center section and ground engaging wheels supporting the center, inboard and outboard frame members and ground engaging components mounted to at least the outboard frame members, said method comprising the steps of:
retracting the ground engaging components towards said outboard frame member;
folding the outboard frame member over onto the inboard frame member;
retracting the outboard ground support wheels towards the outboard frame member; and, folding the inboard frame member onto the center frame member.

14. The method as claimed in claim 13, wherein said outboard frame is folded approximately 180° over said inboard frame member and said inboard frame member is folded approximately 90° towards the center frame member.

15. The method as claimed in claim 13, wherein the ground engaging components are linked by a linkage for simultaneous actuation by a single actuator.

16. The method as claimed in claim 15, wherein said actuator is a hydraulic actuator.

17. The method as claimed in claim 13, wherein actuators are provided, one for each ground engaging component for synchronous actuation to retract said ground engaging components.

18. The method as claimed in claim 17, wherein said actuators are hydraulic and controlled by a hydraulic control system.

19. The method as claimed in claim 13, wherein the ground support wheels are retracted in unison.
